(19) United States
(12) Patent Application Publication
(10) Pub. No.: US 2008/0036862 A1
(43) Pub. Date: Feb. 14, 2008

(54) Digital video surveillance system

(76) Inventors: Steve Lang, Lawrence, KS (US); Barry Siskind, Henderson, NV (US)

Correspondence Address: SHUGHART THOMSON & KILROY, PC, 120 WEST 12TH STREET, KANSAS CITY, MO, 64105, US

(21) Appl. No.: 11/891,381

(22) Filed: Aug. 10, 2007

Related U.S. Application Data
(60) Provisional application No. 60/838,530, filed on Aug. 11, 2006.

(51) Int. Cl. H04N 7/18

(52) U.S. Cl. 348/156

(57) ABSTRACT

A surveillance system is provided having a base unit for receiving digital video and audio transmissions from accessory units equipped with a camera having pan and tilt functions, a motion sensor, an intercom, infrared sensors and a doorbell button for contacting the interior of the dwelling a recording feature is provided to both automatically and on demand record video and audio transmissions received by the base unit from the accessory units.

### CROSS REFERENCE TO RELATED APPLICATION

This application claims priority under 35 U.S.C. 119(e) and 37 C.F.R. 1.78(a)(4) based upon copending U.S. Provisional Application Ser. No. 60/838,530 for Digital Video Surveillance System filed Aug. 11, 2006 and which is incorporated herein by reference.

### FIELD OF THE INVENTION

The present invention comprises a digital video surveillance system which may be used in residential or office applications to provide the observation of individuals appearing at an entrance of the premises. The present invention further provides the ability to link multiple accessory cameras with the control unit for surveillance of alternate locations on the exterior of the premises or within the premises.

### BACKGROUND OF THE INVENTION

The need for home security has become an increasing concern in the United States and elsewhere. The instances of undesirable individuals confronting home owners at the front door of the dwelling under a ruse or entering the property to attempt to break into the home are a constant concern. In addition, the increase of the number of homes of large size and the generally aging population of the United States increase the need for surveillance and communication systems for use in the home which allow individuals to screen visitors to the home and to determine at a distance whether an individual presenting themselves to the home is someone the home owner wishes to personally deal with or avoid.

Heretofore, such surveillance systems have generally been large and cumbersome and required extensive wiring and cabling between the locations to be monitored and a central monitoring device. This level of complication has substantially reduced the convenience of employing such devices and limited the homes in which such devices could be employed to those in which either pre-planning during construction was involved for including such devices or extensive modification of the pre-existing home was made to accommodate such devices.

A further limitation of such previous devices has been the limited ability to monitor the incoming signals from the various accessory devices from various locations of the home. Typically, one or possibly two monitoring stations would be provided and the home owner would find it necessary to be close enough to hear or see those devices when a visitor or intruder activated one of the cameras or monitoring devices. If the home owner was at a distance from the central monitoring device, the home owner may be unaware that an intruder or visitor was near the home where it may not be able to arrive at the vicinity of the central control device until after the visitor had left or the intruder initiated undesirable behavior.

Therefore, it would be a great benefit to homeowners and other building dwellers if a low cost, easily installed, portable surveillance system was available which could transmit audio and video data to a base station without the need to install wired communication links between the base station and the auxiliary units.

It would be a further benefit if the auxiliary units would automatically activate and begin transmitting signals to the base station upon the detection of a visitor or intruder within the vicinity of the base station.

These features and more are included in the digital video surveillance system that is described hereinafter.

### SUMMARY OF THE INVENTION

The system or apparatus provides a home owner with an easily installed, wireless surveillance system. The system comprises multifunctional monitoring devices and includes infrared LEDs to permit low light video observation of visitors and includes standard light video observation. A motion detector is included for sensing the approach of an individual toward one of the motion sensors contained on the auxiliary units. And a microphone and intercom speakers are included for audio communications with the individuals. Signals from all of these multifunctional monitoring devices are transmitted from the accessory or auxiliary devices 14, 16 to base unit or central control unit 12. The base unit is provided with a flash memory or on-board digital memory for user selectable recording of video transmissions from auxiliary devices 14, 16. Base unit 12 also is provided with a communications socket such as a USB port to allow downloading of the recorded digital images from the memory to a computer.

The central control unit 12 may be mounted in a fixed location or may be carried about the home by the individual during the performance of tasks or movement from one location to another. The central observation unit or base unit is in wireless communication with the accessory units and may be hard wired or battery operated to allow user selectability of mobile or fixed location use of the base unit. The sentry positioned and fixed locations and transmit data digitally to the central or base unit thereby eliminating the often poor grade or frequency transmission quality of analog signals used in past devices. In addition, the wireless nature of the present system avoids the need for preplanning of installation or extensive or expensive reconfiguration of existing homes to accommodate the surveillance.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front and right side perspective view of the control unit 12 of the apparatus and which comprises a color LCD screen for viewing video transmission from each of the accessory cameras of the accessory units and front door units, and an intercom and a USB port, and power connection;

FIG. 2 is a left side elevation view of the embodiment of FIG. 1;

FIG. 3 is a front elevation view of the embodiment of FIG. 1;

FIG. 4 is a rear elevation view of the embodiment of FIG. 1;

FIG. 5 a right side elevation view of the embodiment of FIG. 1;

FIG. 6 is a front and right side perspective view of an accessory camera having a television camera with pan and tilt features, a motion sensor, an infrared sensor, an intercom and an RF transceiver for digital communication with the control unit of FIG. 1;

FIG. 7 is a front elevation view of the embodiment of FIG. 6;

FIG. 8 is a right side elevation view of the embodiment of FIG. 6;

FIG. 9 is a rear elevation view of the embodiment of FIG. 6;

FIG. 10 is a front and bottom and right side perspective view of the front door unit which also is equipped with a camera having pan and tilt functions, a motion sensor, an intercom, infrared sensors and a doorbell button which is hard wired to the existing door bell system, and a radio frequency transceiver for communication with the control unit;

FIG. 11 is a top plan view of the embodiment of FIG. 10; and

FIG. 12 is a rear elevation view of the embodiment of FIG. 1;

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

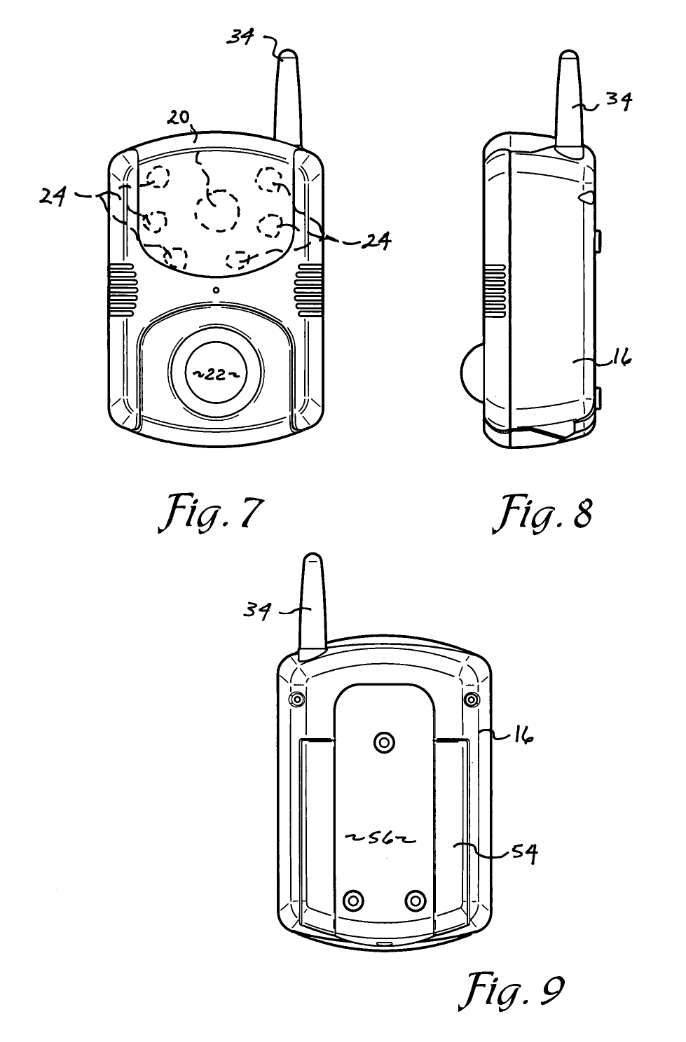

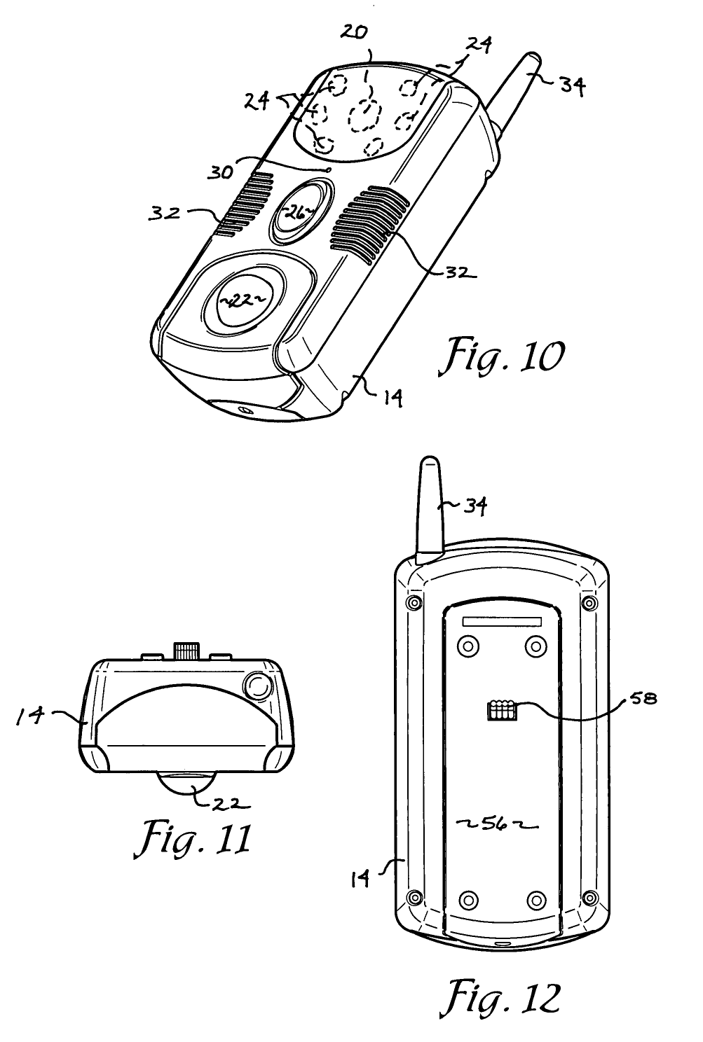

Referring now to FIG. 1 the present invention of the digital video surveillance system 10 is shown comprised of four different units as exemplified in FIGS. 1, 6, and 10. In summary the system is comprised of a control unit 12 (FIG. 1), one or more doorbell units 14 (FIG. 10), and accessory camera units of two different types that may be utilized with the control unit 12 of FIG. 1. The first type of accessory unit is a camera and intercom unit 16 as is shown in FIGS. 6-9 and the second type of accessory unit is a camera only unit without an intercom feature.

Each of the camera units 14,16 interconnects with control unit 12 and allows digital transmission of images to control unit 12. Also incorporated in camera units 14, 16 are a motion sensor for detecting movement in the vicinity of the camera unit 14,16 an infrared sensor for surveillance of the area during the evening and night hours; and rechargeable batteries to avoid the need for hardwiring system on the premises. In addition each of accessory units 14,16 communicates with control unit 12 by wireless digital communications through radio frequency (rf) signals.

In summary, front door unit 14 (FIGS. 10-12) of the present invention 10 replaces the existing doorbells of homes and/or premises. The doorbell unit 14 relies upon the existing wires of the previously installed hardwire doorbell system to power the doorbell and camera unit 14 (FIG. 10). The doorbell device 14 operates as a doorbell and also serves to transmit a video image of any individual approaching the doorbell unit 14 by the video camera 20 in the unit 14. The camera 20 is activated either by activation of the motion sensor 22 or by the pressing of the doorbell 26 on the front door unit 14 (FIG. 10).

The front door unit 14 is preset to record in memory a digital image of an individual pressing the doorbell 26 or to record a video image when the front door unit 14 senses a movement within 3 meters of the unit 14 by motion sensor 22. This information is wirelessly, digitally transmitted to control unit 12 which displays, in real time, digital images of the visitor outside the front door on LCD screen 28. The front door unit 14 also can transmit in real time video transmission of the scene captured by the video camera 20 of unit 14 to control unit or hub unit 12. Similarly, the accessory cameras 16 (with and without intercom) also can transmit for recording by control unit 12 digital pictures of the exterior scene when they detect movement by the motion sensor 22 within each accessory camera. Alternatively, each accessory unit 16 may be preset to display real time images of the camera 20 view on the display on the control unit 12.

The radio frequency wireless digital communication between control unit 12 and accessory units 14, 16 is at 2.4 GHz. This frequency is used for all communications between control unit 12 and the accessory devices 14, 16. These communications include transmission of video, audio and data signals (command instructions) between the control unit 12 and the accessory units 14, 16. It will be appreciated that all accessory devices as well as the control unit have the capacity to transmit and receive signals on the 2.4 GHz frequency and that an alternate frequency may be used.

In operation, each of accessory units 14, 16 is in a standby mode until an event is detected that opens a communications link to control unit 12. For example, if a camera is triggered by the motion sensor 22 or if the front door accessory unit is triggered by depressing of the doorbell button 26 particular accessory device 14, 16 being activated will open an communication link to the control unit 12.

The control unit 12 is the main operational device for this surveillance. All cameras of accessory devices 14, 16 communicate with the control unit 12 and each of the accessory devices 14, 16 must be registered with the control until 12 to operate with the particular control unit 12. As previously stated a maximum of 8 accessory units 14, 16 can be registered with one control 12 unit for display of images from different locations. The control unit 12 is equipped with a color LCD screen 28 which may be of any convenient size and which is used to display the video transmissions received by control unit 12 from accessory units 14, 16.

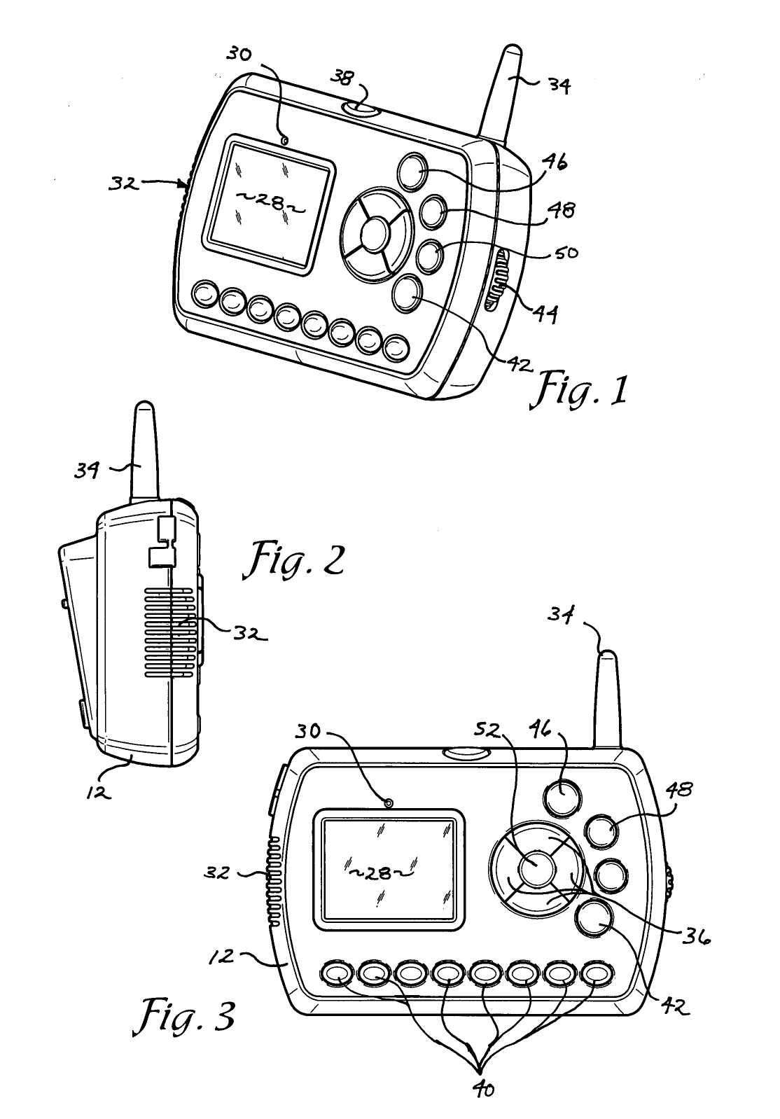

Referring now to FIGS. 1-5, the features of the control unit 12 will be described in greater detail. Control unit 12 is the base unit which the homeowner can position in a fixed location or carry about for mobile contact with the surveillance system. Base unit 12 is provided with LCD video screen 28 which is used to view the video images from the accessory units. Audio communication between base unit 12 and accessory units 14, 16 is by way of microphone 30 which is located just above LCD screen 28 on base unit 12. The received audio transmissions from base units 14, 16 are presented to the user through intercom speaker 32 and base unit 12. It will be appreciated that the radio frequency digital transmissions between base unit 12 and accessory or units 14, 16 are received and transmitted via antenna 34 which is in connection with an internal radio frequency transmitter and radio frequency receiver within base unit 12 and within auxiliary units 14, 16. Base unit 12 is provided with a pan and tilt control which allows movement of the video cameras which are contained within auxiliary units 14, 16. In this manner, a user can view the video cameras contained within auxiliary units 14, 16 to achieve better viewing of the locations surrounding auxiliary units 14, 16.

In operation, the user will turn on the power of base unit 12 using power switch 38. The user may then select a particular auxiliary unit 14, 16 to activate and receive transmissions from by selecting the desired auxiliary device or unit 14, 16 using device selector switches 40 on base unit 12. By contrast, if a visitor or intruder approaches one of auxiliary units 14, 16, that unit will begin transmitting information to base unit 12 in response to motion detectors 22 being activated. In such a case, the user need not select an auxiliary unit to activate using auxiliary device selector switch 40.

The additional controls located on base unit 12 include talk switch 42 to allow the user to transmit voice information through microphone 30 of base unit 12 on a selectable fashion thereby allowing the user to remain unnoticed by a visitor or intruder which might result from unwanted audio transmission from base unit 12. Volume control 44 also is provided to allow the user to adjust the volume of audio transmissions. A video record switch, or “shutter” switch 46 is provided to allow a user to record a video image that is transmitted from one of auxiliary devices 14, 16. Should the user then determine that the recorded video image is unnecessary, delete switch 48 can be employed to eliminate the captured image. Menu switch 50 is provided which allows the user to select the operational and programming menu available within base unit 12 and selector switch or entry switch 52 allows the user to select items displayed using menu switch 50.

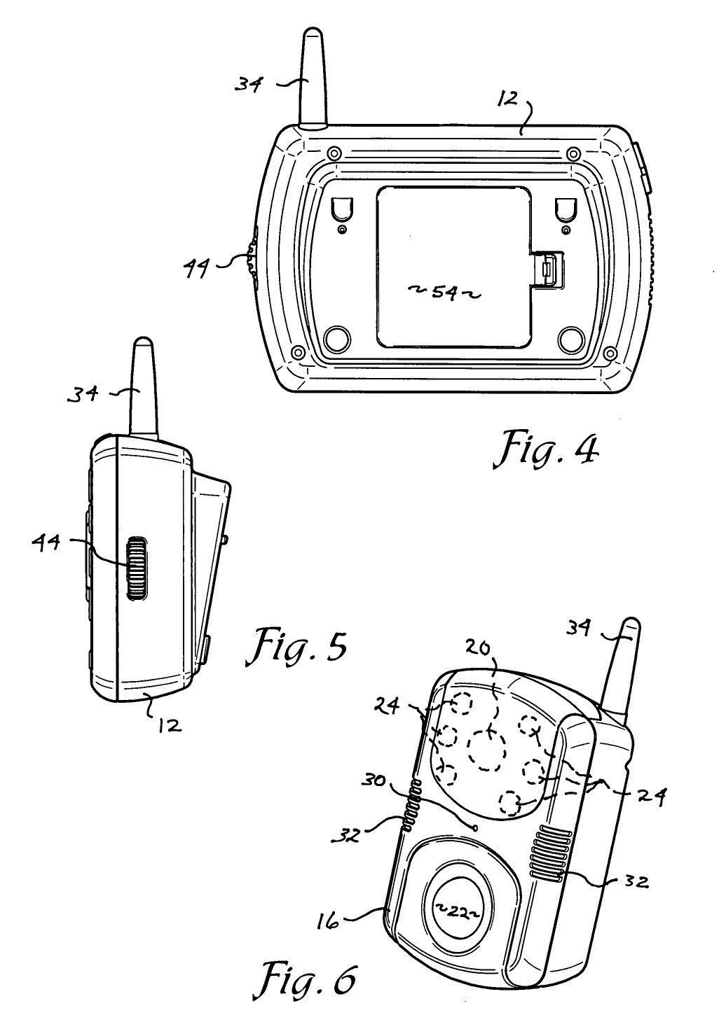

Referring now to FIG. 4, battery cover 54 is located on the rear of base unit 12 which allows for a renewable power supply to portable base unit 12.

Referring now to FIGS. 6-9, the features of auxiliary unit 16 will be described. Auxiliary unit 16 is an auxiliary unit which does not include the doorbell feature found on auxiliary unit 14. Auxiliary unit 16 is available in two different types, one type including a microphone 30 and intercom speaker 32 and a second type which does not include the microphone or intercom speaker feature.

Referring particularly to FIG. 6, auxiliary device 16 is provided with motion sensor 22 which is always on when the system is on and serves to activate camera 20 when motion is detected in the vicinity of auxiliary unit 16 by motion sensor 22. During periods of bad lighting or darkness, auxiliary unit 16 is provided with infrared LED lights 24 which allow imaging of objects by camera 20 during low light circumstances. It will be appreciated that operation of camera 20 has been previously described to the extent that the pan and tilt controls 36 of base unit 12 can be used to redirect the camera 20 to adjust the field of view to objects of interest.

Referring now to FIG. 6, the rear of auxiliary unit 16 is shown which is provided with mounting plate 56 for mounting auxiliary unit 16 onto a surface. Battery cover 54 is also shown permitting replacement of the batteries powering auxiliary unit 16.

Referring now to FIGS. 10-12, the features of auxiliary unit 14 containing a doorbell switch will be discussed. In FIG. 10, the same features as have previously been discussed for auxiliary unit 16 may be found in auxiliary unit 14. These features comprise motion sensor 22 which will activate auxiliary unit 14 upon the approach of an intruder or a visitor to the vicinity of auxiliary unit 14. Alternatively, auxiliary unit 14 is activated when an individual presses doorbell button 26 which activates base unit 12 and in those instances in which auxiliary unit 14 is hard wired into the pre-existing doorbell wiring, auxiliary unit 14 will activate the dwelling doorbell ringer when switch 26 is depressed. Auxiliary unit 14 also is equipped with a video camera 20 which also is controlled by the pan and tilt controls 36 of base unit 12. Again, in low lighting situations, infrared lights 24 are provided on auxiliary unit 14 to allow visualization of intruders or visitors during low lighting situations. Auxiliary unit 14 is provided with a microphone 30 and intercom speakers 32 to allow audio communication between base unit 12 and auxiliary 14.

Referring now to FIG. 12, the rear of auxiliary unit 14 is shown having mounting plate 56 attached thereto to allow convenient mounting of auxiliary unit 14 onto a surface. To allow the connection of auxiliary unit 14 to the pre-existing doorbell wiring of a dwelling, low voltage wires 58 are provided to permit convenient attachment of auxiliary unit 14 to the pre-existing doorbell wiring.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive digital video surveillance system is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A surveillance apparatus comprising:
at least one base unit, said base unit having a radio frequency transmitter and a radio frequency receiver for transmitting and receiving digital radio frequency audio and video signals, a liquid crystal display for displaying received video signals to a user, a speaker for transmitting received audio signals to said user, a microphone for receiving audio signals from said user, a pan and tilt control for signaling and manipulating a remote video camera, a digital video recorder memory for recording video images received by said base unit from said remote video camera, and
at least one first auxiliary unit having a radio frequency transmitter and a radio frequency receiver for transmitting and receiving digital radio frequency audio and video signals to and from said base unit, a speaker for transmitting received audio signals to a visitor, a microphone for receiving audio signals from said visitor for transmission to said base unit, a remote video camera responsive to said pan and tilt control manipulation signals received from said base unit and for receiving a video image for transmission to said base unit and said first auxiliary unit having switch thereon for permitting said visitor to activate a dwelling door bell.

2. The apparatus as claimed in claim 1 further comprising at least one second auxiliary unit comprising a radio frequency transmitter and radio frequency receiver for transmitting and receiving digital radio frequency audio and video signals to and from said base unit, a speaker for transmitting received audio signals to a visitor, a microphone for receiving audio signals from said visitor for transmission to said base unit, a remote video camera responsive to pan and tilt control manipulation signals received from said base unit and for receiving a video image for transmission to said base unit.

3. The apparatus as claimed in claim 1 further comprising a selector switch on said base unit for user determination of which of said auxiliary units said base unit is to receive and transmit signal between.

4. The apparatus as claimed in claim 1 further comprising a plurality of infra-red lights on said first auxiliary unit for providing illumination for said video camera.

5. The apparatus as claimed in claim 2 further comprising a plurality of infra-red lights on said second auxiliary unit for providing illumination for said video camera.

6. The apparatus as claimed in claim 1 further comprising a motion detector on said first auxiliary unit for sensing movement proximate to said first auxiliary unit and to activate transmission of a video signal from said first auxiliary unit to said base unit.

7. The apparatus as claimed in claim 2 further comprising a motion detector on said second auxiliary unit for sensing movement proximate to said second auxiliary unit and to activate transmission of a video signal from said second auxiliary unit to said base unit.

8. A surveillance apparatus comprising:
at least one base unit, said base unit having a radio frequency transmitter and a radio frequency receiver for transmitting and receiving digital radio frequency audio and video signals, a liquid crystal display for displaying received video signals to a user, a speaker for transmitting received audio signals to said user, a microphone for receiving audio signals from said user, a pan and tilt control for signaling and manipulating a remote video camera, a digital video recorder memory for recording video images received by said base unit from said remote video camera,
at least one first auxiliary unit having a radio frequency transmitter and a radio frequency receiver for transmitting and receiving digital radio frequency audio and video signals to and from said base unit, a speaker for transmitting received audio signals to a visitor, a microphone for receiving audio signals from said visitor for transmission to said base unit, a remote video camera responsive to said pan and tilt control manipulation signals received from said base unit and for receiving a video image for transmission to said base unit and said first auxiliary unit having switch thereon for permitting said visitor to activate a dwelling door bell, and
at least one second auxiliary unit comprising a radio frequency transmitter and radio frequency receiver for transmitting and receiving digital radio frequency audio and video signals to and from said base unit, a speaker for transmitting received audio signals to a visitor, a microphone for receiving audio signals from said visitor for transmission to said base unit, a remote video camera responsive to pan and tilt control manipulation signals received from said base unit and for receiving a video image for transmission to said base unit.

9. The apparatus as claimed in claim 8 further comprising a selector switch on said base unit for user determination of which of said auxiliary units said base unit is to receive and transmit signal between.

10. The apparatus as claimed in claim 8 further comprising a plurality of infra-red lights on each of said first and said second auxiliary units for providing illumination for said video camera.

11. The apparatus as claimed in claim 8 further comprising a motion detector in each of said first and second auxiliary units for sensing movement proximate to said first auxiliary unit and/or said second auxiliary unit and to activate transmission of a video signal from said first auxiliary unit or said second auxiliary unit to said base unit.
